(19) United States
(12) Patent Application Publication
(10) Pub. No.: US 2021/0110732 A1
(43) Pub. Date: Apr. 15, 2021

(54) SYSTEMS AND METHODS FOR CLIENT DEVICE FLIGHT SIMULATION USING SERVER SYSTEM DATA

(71) Applicant: Honeywell International Inc., Morris Plains, NJ (US)

(72) Inventors: Raghu SHAMASUNDAR, Bangalore (IN); Mahesh SIVARATRI, Bangalore (IN); Sujith Thirumalamel Kalarikkal, Bangalore (IN); Venkatasai NEELAM, Bangalore (IN)

(73) Assignee: Honeywell International Inc.

(21) Appl. No.: 16/945,467

(22) Filed: Jul. 31, 2020

(30) Foreign Application Priority Data
Oct. 10, 2019 (IN) 201941040968

(51) Int. Cl. G09B 9/24; G09B 9/16; G09B 19/16

(52) U.S. Cl. CPC G09B 9/24; G09B 19/165; G09B 9/16

(57) ABSTRACT

Systems and methods are disclosed for providing data for flight simulation, or performing flight simulation using data provided by a remote server system. In some embodiments, a method for providing data for flight simulation a method may include: receiving, from a client device, a request to perform a flight management system function to generate flight management data usable by the client device for flight simulation; based on the request, performing the flight management function to generate the flight management data; and providing, to the client device, the generated flight management data so that the client device uses the generated flight management data, a guidance function executed on the client device, and a navigation function executed on the client device for flight simulation.

### CROSS-REFERENCE TO RELATED APPLICATION(S)

This patent application claims the benefit of priority under 35 U.S.C. § 119 from Indian Patent Application No. 201941040968, filed on October 10, 2019, the contents of which is incorporated by reference in its entirety.

### TECHNICAL FIELD

Various embodiments of the present disclosure relate generally to flight simulation training for aircraft operations and, more particularly, to systems and methods for providing data to client devices for flight simulation, and performing flight simulations on client devices using data provided by a remote server system.

### BACKGROUND

In order to conduct flight missions safely and efficiency, pilots require adequate training in operating aircraft. Insufficient training may result in aviation accidents. Additionally, flight management systems and other aircraft technologies evolve over time to provide new features that improve safety and efficiency. Pilots who are inadequately trained on recent technologies may be unable to reap the benefits of such technological advancements.

Therefore, there is a need for systems and methods to provide for effective flight simulation, for purposes of training pilots in operating aircraft, on easily accessible computing devices. There is also a need for flight simulations executed on such computing devices to utilize server-hosted resources in a way that does not impair the effectiveness of the flight simulation for training purposes.

The present disclosure is, in certain aspects, directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed providing data to client devices for flight simulation, and performing flight simulation using data obtained provided by a remote server system.

For instance, a method for providing data for flight simulation may include: receiving, from a client device, a request to perform a flight management system function to generate flight management data usable by the client device for flight simulation; based on the request, performing the flight management function to generate the flight management data; and providing, to the client device, the generated flight management data so that the client device uses the generated flight management data, a guidance function executed on the client device, and a navigation function executed on the client device for flight simulation.

Furthermore, a computer system for providing data for flight simulation may include a memory storing instructions; and one or more processor configured to execute the instructions to perform operations, wherein the operations may include: receiving, from a client device, a request to perform a flight management system function to generate flight management data usable by the client device for flight simulation; based on the request, performing the flight management function to generate the flight management data; and providing, to the client device, the generated flight management data so that the client device uses the generated flight management data, a guidance function executed on the client device, and a navigation function executed on the client device for flight simulation.

Furthermore, a non-transitory computer-readable medium may store instructions that, when executed by one or more processors of a computer system, cause the computer system to perform operations for performing flight simulation using data provided by a remote server system. The operations may include: sending, to a server system, a request for first flight management data generated by a first flight management system function executed by the server system; receiving, from the server system, the first flight management data; generating second flight management data by performing further flight management system functions executed on the computer system, the further flight management system functions including a guidance function and a navigation function; and performing flight simulation based on the first flight management data and the second flight management data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a system for flight simulation, according to one or more embodiments.

FIG. 2 depicts an exemplary implementation of the system depicted in FIG. 1, according to one or more embodiments.

FIG. 3 depicts a server system, according to one or more embodiments.

FIG. 4 is a flowchart depicting a method for providing data to client devices for flight simulation, according to one or more embodiments.

FIG. 5 is a flowchart depicting a method for performing flight simulation using data provided by a remote server system, according to one or more embodiments.

FIG. 6 depicts a computer system, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value. The term “training,” when used in the context of training aircraft operations in operating aircraft, encompasses concepts of familiarization.

In the following description, embodiments will be described with reference to the accompanying drawings. As will be discussed in more detail below, the functions of a flight management system (FMS) used for flight simulation may be hosted partially on a user device and partially on a server system. Accordingly, the user device, which may be a hand-held computing device used for training purposes, may utilize the locally hosted functions, so as to avoid large usage of bandwidth by such functions, as well as impairment of such functions due to latency, if the functions were instead hosted on the server system. For example, guidance and navigation functions of a flight management system, which would require high bandwidth and low latency if hosted on the server system, may be hosted locally on the user device. Meanwhile, by hosting certain FMS functions and other functionalities used in flight simulation on the server system, the flight simulation presented at the user device may still leverage server technologies, such as cloud computing.

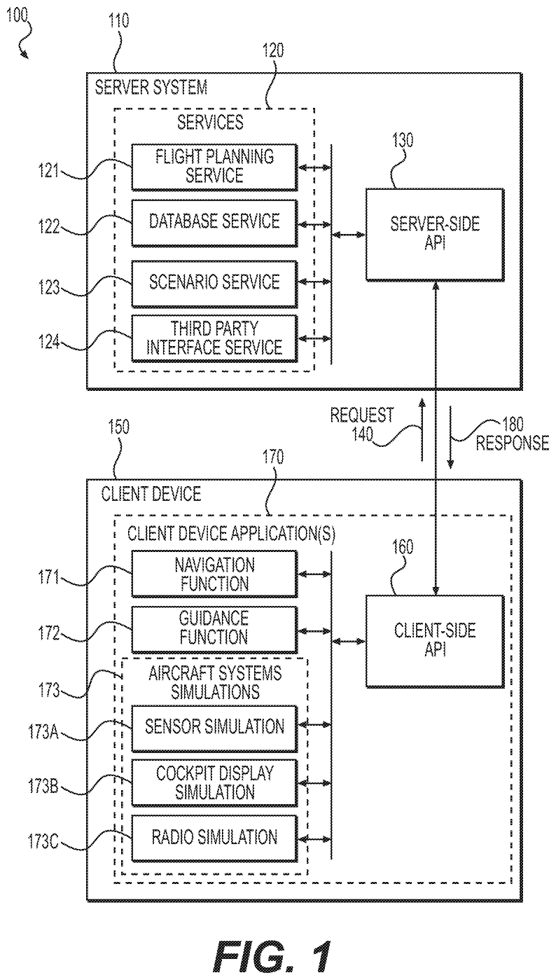

FIG. 1 illustrates a system 100 for providing flight simulation training, according to one or more embodiments of the present disclosure. The system 100 may include a server system 110 and a client device 150.

Server system 110 may be a computer system that operates services 120 configured to perform various functionalities and missions. For example, as will be discussed in more detail below, services 120 may provide data to one or more client device applications 170 executed on client device 150. Based on data received from the services 120, the one or more client device applications 170 may simulate avionics systems used on aircraft for purposes of, for example, training or familiarizing aircraft operators. Server system 110 may have a server-side API 130 used to interface with client device 150.

Server system 110 may be any suitable computer system. In some embodiments, server system 110 may have a cloud computing platform with scalable resources for computation and/or data storage, and may run software components on the cloud computing platform to perform the aforementioned functionalities. In such embodiments, the services 120 may be referred to as cloud services, and server-side API 130 may be referred to as a cloud service API.

Client device 150 may be any suitable computer system. In some embodiments, client device 150 may be, for example, a personal computer such as a laptop or desktop computer, or a mobile computing device such as a tablet computer or smartphone. A mobile computing device may also be referred to as a hand-held computing device. The user of the client device 150 may be an aircraft operator, such as a pilot, flight crew, or flight instructor.

As noted above, flight simulation may be performed by the one or more client device applications 170 executed on client device 150. The one or more client device applications 170 may run various aircraft systems simulations 173 to simulate aircraft avionics for training the aircraft operator in a certain topic. Examples of topics for training include engine out scenarios, RNP/LPV/FLS approach scenarios, and search and rescue patterns. As will be described below in more detail, system 100 may implement a remote data concentrator framework for flight simulation. In such a framework, the flight simulation performed by the one or more client device applications 170 may utilize data generated at both the client device 150 and the server system 110.

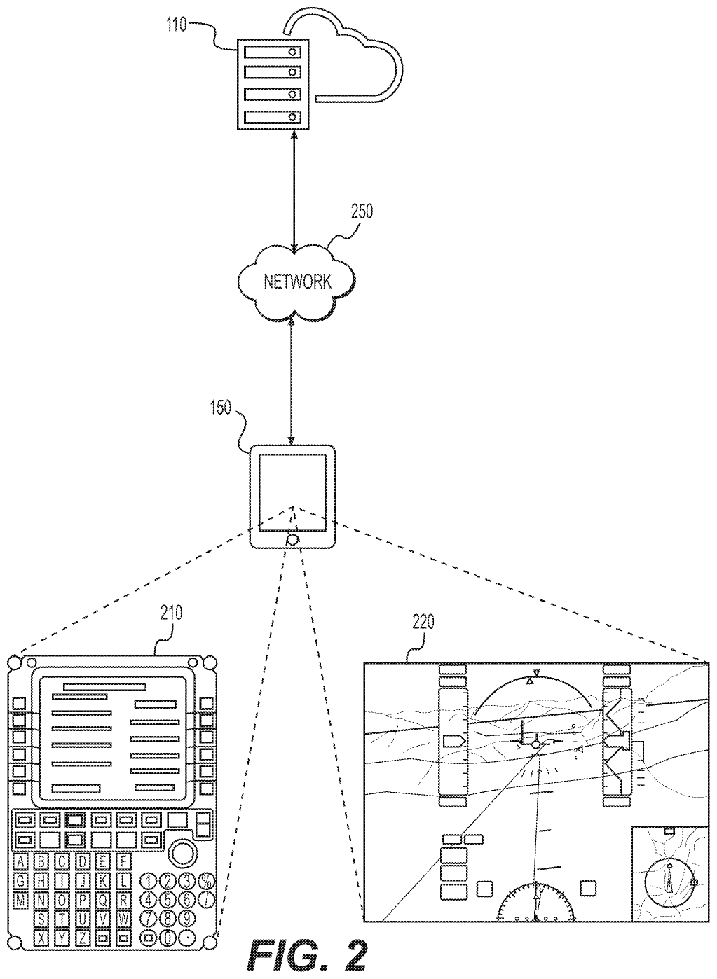

FIG. 2 illustrates an exemplary implementation of the system 100 of FIG. 1. In FIG. 2, the server system 110 is illustrated as a cloud server system, and the client device 150 is illustrated as a tablet computer. As shown in FIG. 2, the server system and the client device 150 may be connected to one another through an electronic network 250 that enables communication between the various components connected thereto. Electronic network 250 may be, for example, one or a combination of a public network (e.g., the internet), a local network, or other network. The client device 150 may simulate the functionalities of avionics systems on a display screen of the client device 150.

Examples of avionics systems that may be simulated by the client device applications 170 include aircraft sensors, cockpit displays, and/or other systems used onboard aircraft. Examples of avionics functionalities of such avionics systems that may be simulated by aircraft systems simulations 173 include display functionalities, data processing functionalities, and user-input functionalities.

For example, the aircraft systems simulations 173 may include an aircraft sensor simulation 173A that simulates one or more sensors used on aircraft, a cockpit display simulation 173B that simulates one or more cockpit displays used on aircraft, and a radio simulation 173C that simulates one or more radio devices used on aircraft. Examples of sensors used on aircraft include attitude and heading reference systems (AHRS) and global positioning systems (GPS). Examples of cockpit displays include primary flight displays (PFD), multi-function control and display units (MCDU), multi-function displays (MDF), navigation displays (ND), vertical situation displays (VSD), crew alerting systems (CAS), engine synoptics displays, and interactive navigation (INAV) systems.

For example, as shown in FIG. 2, cockpit display simulation 173B may control the client device 150 to display a screen 210 simulating an MCDU, or a screen 220 simulating a primary flight display (PFD). Aircraft systems simulations 173 may also simulate various control panels used onboard aircraft, such as guidance control panels and EFIS control panels. In the example shown in FIG. 2, screen 210 may include a simulation of both the display and the control panel of an MCDU.

Simulation screens of cockpit displays, such as screens 210 and 220, may be graphically displayed in any suitable application, such as a browser, an app, or other software application. In some embodiments, cockpit display simulation 173B may control the graphical display of such simulation screens. Simulations of avionics systems on client device 150 may utilize data provided by server system 110, as will be described below in more detail.

A user of the client device 150 who seeks to learn flight scenarios (e.g., engine out scenarios, scenarios of flying RNP/LPV/FLS approaches, and scenarios involving search and rescue patterns) using aircraft systems simulations 173 may benefit from realistic interactions with simulated flight controls and other simulated functionalities of an aircraft. In order to provide interactive tools to train aircraft operators through simulations presented at client device 150, server system 110 may be configured to run a flight management system (FMS) application with the data processing functionalities of an on-board FMS, run whole aircraft flight simulations in the cloud (which may include, for example, simulations of aircraft sensors, cockpit controls and panels, and external flight environment), and stream data for cockpit displays, control panels, and external flight environments to the client devices.

However, fully streaming simulation data from the server system 110 to the client device 150 may require large amounts of data to be exchanged between the guidance and navigation functions of a FMS application and the aircraft systems simulations 173. Such data may also need to be exchanged at a high stability and a low latency in order to provide the user with an adequate training experience.

In more detail, a fully-streamed approach may incur the challenges described below. First, an FMS used onboard aircraft may be a real-time embedded system having navigation and guidance functions that may be time highly time critical, with respect to timing and periodicity, for example. The guidance and navigation functions of an onboard FMS may run at a periodicity of micro-seconds and may communicate and exchange data with aircraft sensors and flight controls in a closed loop. Such characteristics may need to be replicated in order to realize flight simulation training. Second, streaming data between a server and a client device may pose potential issues resulting from latency between user interactions with displays and controls on the client device and response to those interactions generated by the server. Such latency may lead to navigation and guidance malfunctions, so as to result in ineffective flight simulation training. Third, aircraft cockpits may have many display units (e.g., MCDU, PFD, INAV, VSD, CAS, engine synoptics, etc.) and many control panels (guidance control panel, EFIS control panel, etc.). Therefore, streaming data for multiple types of displays and control panels simulation may require high network bandwidth. Fourth, potential delays in the refresh rates of content displayed on hand-held/portable devices, due to large amounts of data being streamed between cloud and device or other reasons, may lead to ineffective flight scenarios training.

In view of the above considerations, according to various embodiments of the present disclosure, the server system 110 and the client device 150 may be configured to operate in a manner such that the functionalities of a flight management system are provide by the combination of the server system 110 client device 150. For example, as will be discussed below in more detail, core flight management functions, such as navigation functions and guidance functions, may be provided on the client device 150 (e.g., as navigation functions 171 and guidance functions 172), while other functions may be provided by the services 120 accessible through server-side API 130. A system in which the functionalities of an aircraft system, such as a flight management system, are provide by the combination of the server system 110 client device 150 may be referred to as a data concentrator, or, in cloud computing implementations, a cloud-based remote data concentrator (CBRDC).

The functionalities of a flight management system may include, for example, flight route planning, flight route trajectory generation, flight scenarios assessments and optimizations, navigation, and guidance functions. As noted above, navigation and guidance functions, when implemented onboard aircraft, may be time-critical in that they may run at micro-seconds periodicities and may communicate intensely with flight controls and aircraft sensors in a closed loop. Navigation and guidance functions may also produce flight commands controlling the roll, pitch, and/or yaw of an aircraft. Such commands may control flight surfaces (e.g., ailerons, rudders, and elevators) of an aircraft. Navigation and guidance functions onboard aircraft may also read back information (e.g., altitude) obtained from aircraft sensors (e.g., AHRS and GPS) in order to fly a given flight route.

Therefore, as shown in FIG. 1, in order to implement an FMS for purposes of flight simulation training provided by client device 150, navigation functions 171 and guidance functions 172 may be implemented locally on client device 150. These functions may be part of one or more client device applications 170. By hosting flight management system guidance and navigation functions 171 and 172 on client device 150, along with aircraft simulations 173, the client device 150 may provide flight scenario simulations to the user while being less affected by latency and/or bandwidth constraints. Accordingly, the one or more client device applications 170 and their associated logic may be able to run more smoothly in providing flight scenarios simulation to the user.

In order to run the aircraft systems simulations 173, the client device 150 may request additional data, such as flight mission scenarios, from server system 110 in order to perform aircraft simulation for training purposes. Based on flight mission scenarios received from server system 110, the guidance function 171 and navigation function 172 on the client device 150 may fly the flight scenario by closely interacting with the aircraft systems simulations 173.

In general, the data requested from server system 110 may be any data that is not generated by a function locally hosted on client device 150. For example, the data requested from server system 110 may be data generated by non-critical avionic functionalities. In embodiments in which the client device 150 locally hosts navigation functions 170 and guidance functions 172, as described above, the additional data requested from server system 110 may be data other than outputs of navigation and guidance functions.

Referring again to FIG. 1, the client device 150 and the server system 110 may communicate through server-side API 130 and client-side API 160. In order to receive data generated by the services 120 of the server system 110, any of the client device applications 170 may generate a request 140 to be transmitted to server system 110 through the server-side API. The request 140 may be received by one or more of the services 120, which, upon receipt of the request 140, may generate a response 180 to be transmitted to the client device 150 through the server-side API 130.

Server-side API 160 and client-side API 130 may each be a Representational State Transfer (REST) API. In some embodiment, the server-side API may accept and generate messages encoded in JSON (but not necessarily limited to JSON), in which case messages sent between the client device 150 and the server-side API adapter 140 may be referred to as JSON/REST messages. A request from client device 150 may be referred to as a REST API request, and a response from the server system 110 may be referred to as a REST API response.

As described above, system 100 may provide an infrastructure to host the guidance and navigation functions on a client device 110 which may be a hand-held computing device. In particular, the infrastructure may provide for flight simulation on a client device 150, such as a hand-held computing device, utilizing functionalities hosted on both the client device 150 and the server system 110. Client device 110 may host aircraft systems simulations 173 and navigation and guidance functions 171 and 172 that communicate exchange with the aircraft systems simulations 173. Functionality upgrades to the one or more client device applications 170 may be delivered by the services 120 of the server system.

By utilizing server-side API 160, the navigation and guidance functions 171 and 172 of the client device 120 may access any of the service 120 hosted on the server system 110, such as flight planning service 121. The one or more client device application 170 may, for example, request a flight module, which the services 120 may provide in response to the request. The services 120 may enable the client device 120 to obtain different configurations, including the database information and performance loads based on the training interest of the user of the client device 120.

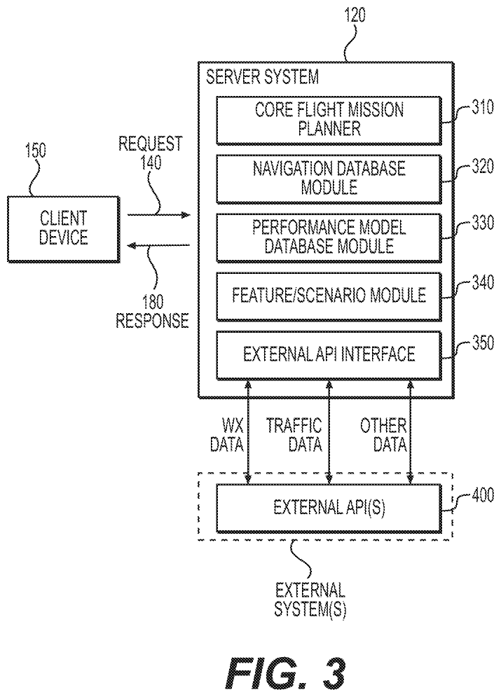

FIG. 3 illustrates features of the server system 110. As shown, the server system 110 may include a core flight mission planner 310, a navigation database module 320, a performance model database module 330, a feature/scenario module 340, and an external API interface 350. These components of server system 110 shown in FIG. 3 may be software components executed by the server system 110, and may provide one or more services used by the client device 150, as described below in more detail.

Core flight mission planner 310 may provide a flight planning service (e.g., flight planning service 121 shown in FIG. 1) that performs functionalities such as flight route planning, flight route trajectory generation, and flight scenario assessment, and/or flight scenario performance optimization. For example, the request 140 received by the server-side API 130 may invoke flight planning services to generate a trajectory or flight plan based on input parameters included in the request 140. Such input parameters may indicate, for example, a desired flight route, or a base flight route and a desired modification of the flight route. The input parameters may include any flight data that may be used by flight management systems to generate a trajectory. The response 180 may include the requested trajectory. The response 180 may further include performance data.

Navigation database module 320 may provide a service (e.g., database service 122) configured to validate a given record against a navigational database. For example, the request 140 from the client device 150 may be a request describing a certain navigational feature (e.g., a waypoint, navaid, or airport) and requesting the server system 110 to validate the navigational feature. Such a request may be referred to as a validation request, or waypoint request, navaid request, or airport request. The response 180 may indicate the result of the validation process, such as whether the navigational feature requested for validation is valid or not valid. In this context, whether a navigational feature is valid or not valid may, for example, refer to whether the navigational feature as described by the request 140 exists in a navigational database stored in server system 110.

Performance model module 330 may provide a service configured to provide a performance model of an aircraft. The performance model may be generated or selected from a database of existing models based on one or more input parameters. For example, the request 140 from the client device 150 may indicate a characteristic of an aircraft, such as an identifier (e.g., tail number), aircraft model, or aircraft type. Such a request may be referred to as a performance model request. Based on the characteristic, the performance module 330 may generate or select an appropriate performance model, which may be included in response 180 transmitted to the client device 150. The performance model module 330 may be used by the client device 150 to create a flight scenario with realistic environment parameters.

Feature/scenario module 340 may provide a service (e.g., scenario service 123) configured to generate a scenario or feature model based on the request 140 received from the client device 150. A scenario may be, for example, a flight scenario designed to train the user of the user device 150 in understanding the functionalities of an aircraft system. A scenario may be, for example, designed to take the user through an intended sequence of aircraft operations. A feature model may include data usable by the client device 150 to provide training on a certain feature of an aircraft. The scenario or feature model may be generated based on the request 140. For example, the request 140 may be a flight scenario request or feature model request that specifies a flight environment condition, such as a weather condition and/or traffic condition. For example, the request 140 may request a route with normal and/or worst case weather to create a scenario or feature model, or may request a route with normal and/or worst case traffic to create a scenario or feature model.

In some embodiments, the generation of the scenario or feature model may be based on a particular aircraft tail number and/or aircraft operator information (e.g., a pilot profile). The generation of the scenario or feature model may be further based on a performance model generated by the performance model module 330, and/or data from an external party API that is obtained by the external API interface 350.

External API interface 350 may provide a mechanism to interact with external API(s) 400 of external system(s) that serve as data sources. For example, the external API(s) may store weather data, traffic data, and/or other data (e.g., configuration data). Such data may be obtained by the external API interface 350 for use by the server system 110. In some embodiments, the server system 110 may operate a service (e.g., third party interface service 124) that retrieves data from the external API(s) 400. This service may be utilized by client device 150 or by other components of the server system 110.

In order to utilize a particular one of the services described above, the one or more client device applications 170 may generate the request 140 to include data that is recognized by the server system 110 as a request to invoke the particular service. It is noted that while the services described above may be utilized by client device 150, they may also be utilized by other services of the server system.

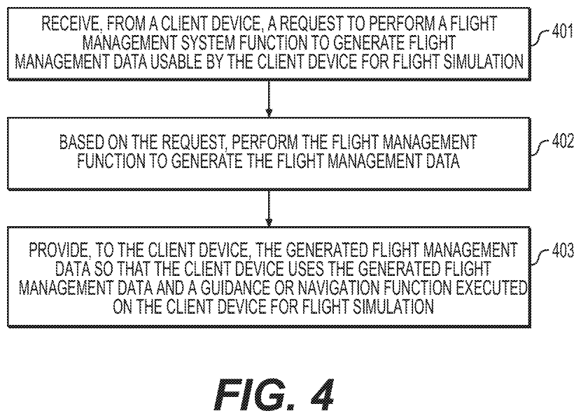

FIG. 4 is a flowchart illustrating a method for providing data for flight simulation, according to one or more embodiments of the present disclosure. The method may be performed by server system 110.

Step 401 may include receiving, from a client device (e.g., client device 150), a request to perform a flight management system function to generate flight management data usable by the client device for flight simulation. The flight management system function may be a function performed by flight planning service 121. The management system function may be, for example, a flight route planning function, a flight route trajectory generation function, a flight scenario assessment function, or a flight scenario assessment optimization function. In some examples, the request may be indicative of a flight route and flight data, the flight management function may be a flight route trajectory generation function, and the flight management data may include a trajectory.

Step 402 may include performing the flight management function to generate the flight management data, based on the request.

Step 403 may include providing, to the client device, the generated flight management data so that the client device uses the generated flight management data and a guidance or navigation function executed on the client device for flight simulation.

While certain aspects of the method illustrated in FIG. 4 have been discussed above, it is noted that the method may generally include the utilization of any of the functionalities of the server system 110 described above. For example, the server system 110 may provide, upon request from client device 150, additional data generated by any of the services 120 for use in the flight simulation performed on client device 150.

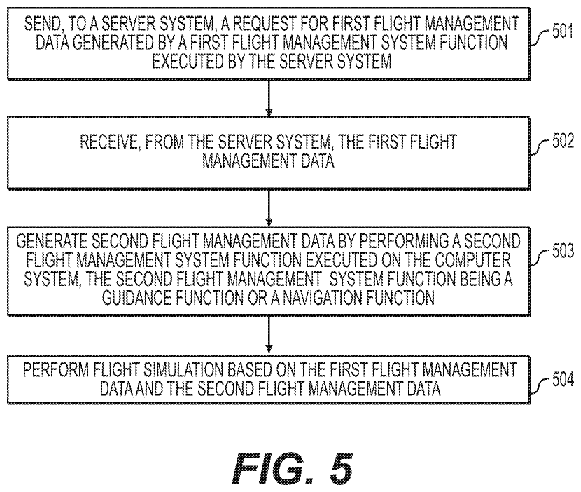

FIG. 5 is a flowchart illustrating a method for flight simulation. The method may be performed by client device 150.

Step 501 may include sending, to a server system (e.g., server system 110), a request for first flight management data generated by a first flight management system function executed by the server system. The first flight management function may be, for example, a flight route planning function, a flight route trajectory generation function, a flight scenario assessment function, or a flight scenario assessment optimization function.

Step 502 may include receiving, from the server system, the first flight management data. The first flight management data may be any output of the first flight management function. For example, the flight management function may be a flight route trajectory generation function, and the flight management data may include a trajectory.

Step 503 may include generating second flight management data by performing a second flight management system function executed on the computer system, the second flight management system function being a guidance function (e.g., guidance function 172) or a navigation function (e.g., navigation function 171).

Step 504 may include performing flight simulation based on the first flight management data and the second flight management data. In some embodiments, performing the flight simulation may include simulating a display screen of an aircraft display system based on the first flight management data and the second flight management data, and displaying the simulated display screen on a display. Such flight simulation may utilize any of the aircraft system simulations 173 described above.

While certain aspects of the method illustrated in FIG. 5 have been discussed above, it is noted that the method may generally include the use of any of the functionalities of the client device 110 described above. For example, the client device 110 may request additional data provided by any of the services 120 for use in the flight simulation.

As discussed above, in system 100, core flight management functions such as guidance and navigation functions may be run on a client device 150 (e.g., a portable device), while other functions may be run on server system 110 accessible through the services 120. Accordingly, it is possible to perform flight simulation on client device 150, such as a hand-held computing device, utilizing functionalities hosted on both the client device 150 and the server system 110. By hosting certain FMS functions and other functionalities used in flight simulation on the server system, the flight simulation presented at the user device may still leverage server technologies, such as cloud computing.

In general, any process discussed in this disclosure that is understood to be computer-implementable, such as the process shown in FIG. 2 and the processes described in connection with FIGS. 3A-3B, may be performed by one or more processors of a computer system, such as first computer system 110 and/or second computer system 120, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or another type of processing unit.

A computer system, such as server system 110 and/or client device 150, may include one or more computing devices. If the one or more processors of the computer system are implemented as a plurality of processors, the plurality of processors may be included in a single computing device or distributed among a plurality of computing devices. If a computer system comprises a plurality of computing devices, the memory of the computer system may include the respective memory of each computing device of the plurality of computing devices.

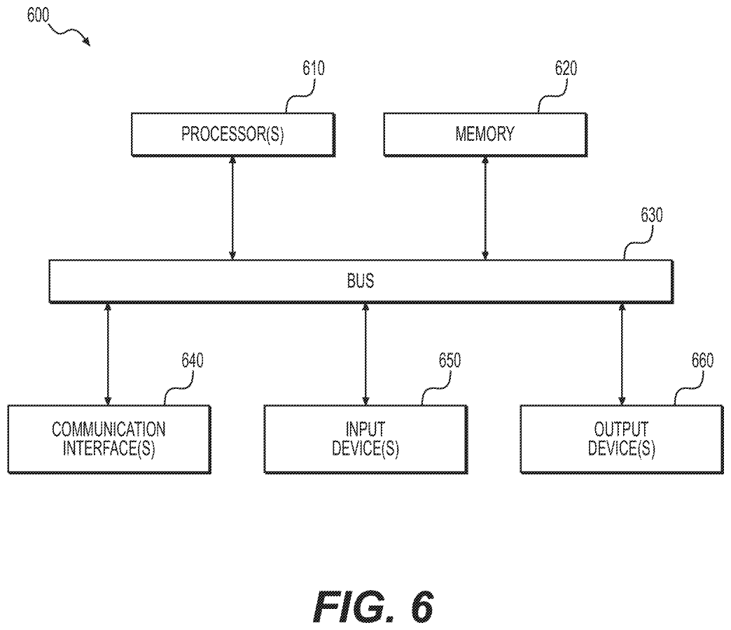

FIG. 6 illustrates an example of a computing device 600 of a computer system. The computing device 600 may include processor(s) 610 (e.g., CPU, GPU, or other processing unit), a memory 620, and communication interface(s) 640 (e.g., a network interface) to communicate with other devices. Memory 620 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 620. The computing device 600 may, in some embodiments, further include input device(s) 650 (e.g., a keyboard, mouse, or touchscreen) and output device(s) 660 (e.g., a display, printer). For example, if the client device 150 is embodied as a tablet computer, as shown in FIG. 2, the client device may have a touchscreen and a display. The aforementioned elements of the computing device 600 may be connected to one another through a bus 630, which represents one or more busses. In some embodiments, the processor(s) 610 of the computing device 600 includes both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, configure and/or cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

What is claimed is:

1. A computer-implemented method for providing data for flight simulation, the method comprising:
receiving, from a client device, a request to perform a flight management system function to generate flight management data usable by the client device for flight simulation;
based on the request, performing the flight management function to generate the flight management data; and
providing, to the client device, the generated flight management data so that the client device uses the generated flight management data, a guidance function executed on the client device, and a navigation function executed on the client device for flight simulation.

2. The method of claim 1, wherein the flight management system function is a flight route planning function, a flight route trajectory generation function, a flight scenario assessment function, or a flight scenario assessment optimization function.

3. The method of claim 1, wherein
the request is indicative of a flight route and flight data,
the flight management function is a flight route trajectory generation function, and
the flight management data includes a trajectory.

4. The method of claim 1, further comprising:
receiving, from the client device, a validation request requesting validation of a navigational feature;
determining a validation result indicative of whether the navigational feature is valid; and
providing, to the client device, the determined validation result, the validation result being usable by the client device for flight simulation.

5. The method of claim 1, further comprising:
receiving, from the client device, a performance model request requesting a performance model for aircraft having a characteristic;
selecting the performance model based on the characteristic; and
providing, to the client device, the selected performance model.

6. The method of claim 1, further comprising:
receiving, from the client device, a flight scenario request requesting a flight scenario having a weather or traffic condition,
generating a flight scenario based on the weather or traffic condition; and
providing, to the client device, the generated flight scenario.

7. A computer system for providing data for flight simulation comprising:
a memory storing instructions; and
one or more processor configured to execute the instructions to perform operations including:
receiving, from a client device, a request to perform a flight management system function to generate flight management data usable by the client device for flight simulation;
based on the request, performing the flight management function to generate the flight management data; and
providing, to the client device, the generated flight management data so that the client device uses the generated flight management data, a guidance function executed on the client device, and a navigation function executed on the client device for flight simulation.

8. The computer system of claim 7, wherein the flight management system function is a flight route planning function, a flight route trajectory generation function, a flight scenario assessment function, or a flight scenario assessment optimization function.

9. The computer system of claim 7, wherein
the request is indicative of a flight route and flight data,
the flight management function is a flight route trajectory generation function, and
the flight management data includes a trajectory.

10. The computer system of claim 7, wherein the operations further comprise:
receiving, from the client device, a validation request requesting validation of a navigational feature;
determining a validation result indicative of whether the navigational feature is valid; and
providing, to the client device, the determined validation result, the validation result being usable by the client device for flight simulation.

11. The computer system of claim 7, wherein the operations further comprise:
receiving, from the client device, a performance model request requesting a performance model for aircraft having a characteristic;
selecting the performance model based on the characteristic; and
providing, to the client device, the selected performance model.

12. The computer system of claim 7, wherein the operations further comprise:
receiving, from the client device, a flight scenario request requesting a flight scenario having a weather or traffic condition,
generating a flight scenario based on the weather or traffic condition; and
providing, to the client device, the generated flight scenario.

13. A non-transitory computer-readable medium storing instructions that, when executed by one or more processors of a computer system, cause the computer system to perform operations for performing flight simulation using data provided by a remote server system, the operations including:
sending, to a server system, a request for first flight management data generated by a first flight management system function executed by the server system;
receiving, from the server system, the first flight management data;
generating second flight management data by performing further flight management system functions executed on the computer system, the further flight management system function including a guidance function and a navigation function; and
performing flight simulation based on the first flight management data and the second flight management data.

14. The non-transitory computer-readable medium of claim 13, wherein the first flight management function is a flight route planning function, a flight route trajectory generation function, a flight scenario assessment function, or a flight scenario assessment optimization function.

15. The non-transitory computer-readable medium of claim 13, wherein
the request is indicative of a flight route and flight data,
the first flight management function is a flight route trajectory generation function, and
the first flight management data includes a trajectory.

16. The non-transitory computer-readable medium of claim 13, wherein
the operations further include:
sending, to the server system, a validation request requesting validation of a navigational feature;
receiving, from the server system, a validation result indicative of whether the navigational feature is valid, and
the flight simulation is performed based further on the received validation result.

17. The non-transitory computer-readable medium of claim 13, wherein
the operations further include:
sending, to the server system, a performance model request requesting a performance model for aircraft having a characteristic; and
receiving, from the server system, the performance model, and
the flight simulation is performed based further on the received performance model.

18. The non-transitory computer-readable medium of claim 13, wherein
the operations further include:
sending, to the server system, a flight scenario request requesting a flight scenario having a weather or traffic condition; and
receiving, from the server system, the flight scenario, and the flight simulation is performed based further on the received flight scenario.

19. The non-transitory computer-readable medium of claim 13, wherein the flight simulation includes:
simulating a display screen of an aircraft display system based on the first flight management data and the second flight management data, and
displaying the simulated display screen on a display.

20. The non-transitory computer-readable medium of claim 13, wherein
the operations further include simulating an aircraft sensor to obtain aircraft sensor data, and
the simulating the display screen is based on further on the aircraft sensor data.
